(19) United States
(12) Patent Application Publication
(10) Pub. No.: US 2022/0287905 A1
(43) Pub. Date: Sep. 15, 2022

(54) JOINT MOBILIZATION APPLIANCE FOR THE DISTAL LOWER EXTREMITY

(71) Applicants: Benjamin Hannula, Fircrest, WA (US); Chad McCann, Tacoma, WA (US)

(72) Inventors: Benjamin Hannula, Fircrest, WA (US); Chad McCann, Tacoma, WA (US)

(21) Appl. No.: 17/200,644

(22) Filed: Mar. 12, 2021

(51) Int. Cl. A61H 1/02

(52) U.S. Cl. CPC A61H 1/0266; A61H 2201/1253; A61H 2201/149; A61H 2201/1642; A61H 2201/0192; A61H 2201/5069

(57) ABSTRACT

A joint mobilization appliance for the distal lower extremity including a frame with hinges, cable pulley system, talar strap, heel support, foot orthotic, and baseplate.

### BACKGROUND

Joint mobilization is a type of manual therapy performed by a physical therapist, often in a physical therapy setting or clinic. It involves the passive movement of specific joints using the skilled application of force, direction, and technique. A physical therapist can use his or her hands to mobilize an affected joint or may elect to use certain tools, including straps, to help deliver the desired treatment effect.

The specific type, magnitude, speed, and frequency of joint mobilization performed depends on several factors, including the goal of treatment, the type of joint being targeted, and human anatomy. The primary effects of joint mobilizations include pain reduction, improved range of motion, and improved quality of joint movement itself, i.e., arthrokinematics.

A posterior glide or translation is a type of joint mobilization technique mainly indicated to increase ankle dorsiflexion range of motion. When performing this joint mobilization, the patient lies supine with the leg supported on the table and the heel over the edge. The therapist, standing to one side of the patient, can stabilize the leg with his or her cranial hand or use a belt to secure the leg to the table. The therapist then places the palmar aspect of the web space of his or her other hand over the talus just distal to the mortise. Wrapping his or her fingers and thumb around the foot to stabilize and maintain the ankle in resting position, a distraction force can be applied in a caudal direction and the talus is glided posteriorly (Graded I-IV) with respect to the tibia by pushing against the talus.

Optimal ankle dorsiflexion range of motion is crucial for normal daily function, including, but not limited to, walking, stair descent, squatting, and balance, as well as more dynamic movement, including, but not limited to, running, jumping, and changes of direction. The ankle joint must move through full, normal ranges of motion to meet the requirements of a person's environment and activity to avoid injury to the ankle and other joints, tendons, and muscles and other tissues through the kinetic chain. Medical providers often seek to restore ankle dorsiflexion to treat dysfunction and prevent future injury.

While medical providers are focused on manual joint mobilizations, as a form of passive movement treatment for musculoskeletal conditions, such as altered joint mechanics of the human ankle, more and more patients are seeking to create, strengthen, improve, restore, and rehabilitate ankle dorsiflexion range of motion and forefoot push-off power through the unassisted use of an externally applied orthopedic device or orthosis.

### SUMMAKY

An exemplary embodiment involves a joint mobilization appliance having a frame which includes spaced-apart dual struts defining an anterior opening between the struts to substantially receive a lower leg, ankle, and foot of a human subject. The dual struts can be oppositely disposed in parallel to one another and each strut can include an inward facing side. A first strut and a second strut of the dual struts can each be pivotally hinged to a first brace and a second brace of the frame.

In variations of the joint mobilization appliance, the appliance can include a talar strap having a tensioner to stabilize a talus bone of the human subject and a cable pulley system including a cable and at least one pulley wheel with an axle. The pulley wheel can be mounted on the frame. The cable can include a first end and a second end, in which the first end can be coupled to a first end of the talar strap. The cable can be strung in a posterior direction from the first end of talar strap to engage at least a portion of the pulley wheel. The cable can then be strung in a proximal direction from the pulley wheel along the inward facing side of the first strut. The second end of the cable can be coupled to the first strut toward a proximal end of the first strut.

In other variations of the joint mobilization appliance, the appliance can include a foot orthotic constructed to at least partially receive the foot of the human subject. The foot orthotic can be detachably coupled to a baseplate. The baseplate can be coupled to the first brace and second brace of the frame with the dual struts substantially perpendicular to the frame.

In further variations of the joint mobilization appliance, the appliance can include a heel bracket mounted to the baseplate. The heel bracket includes an adjustably repositionable backstay to substantially receive at least a heel of the human subject.

In yet further variations of the joint mobilization appliance, the human subject drives at least a portion of their knee anteriorly towards a distal end of the foot, resulting in a pivot actuation of the dual struts to tension the cable pulley system.

Other advantages, features, and functions of embodiments of a joint mobilization appliance having the features discussed herein will become readily apparent and better understood in view of the following description and accompanying drawings. The following description is not intended to limit the scope of the joint mobilization appliance, but instead merely provides exemplary embodiments for ease of understanding.

### BRIEF DESCRIPTION OF THE DRAWINGS

Corresponding reference numerals indicate corresponding parts throughout the several views of the drawings.

FIG. 1 is a top, right side perspective view of a joint mobilization appliance, in accordance with implementations of the present disclosure;

FIG. 2 is a left side view illustrating the talar strap of the joint mobilization appliance, in accordance with implementations of the present disclosure;

FIG. 3 is a left side view illustrating the talar strap and ankle dorsiflexion range of motion, in accordance with implementations of the present disclosure;

FIG. 4 is a left side view of the joint mobilization appliance externally applied by the subject, in accordance with implementations of the present disclosure;

FIG. 5 is a left side view of the joint mobilization appliance with the subject performing an ankle dorsiflexion range of motion, in accordance with implementations of the present disclosure;

FIG. 6 is a top, right side perspective view of a top side of a foot orthotic of the joint mobilization appliance, in accordance with implementations of the present disclosure;

FIG. 7 is a top, right side perspective view of a bottom side of the foot orthotic of the joint mobilization appliance, in accordance with implementations of the present disclosure; and

FIG. 8 is a left side view of the joint mobilization appliance externally applied by the subject while wearing a cleated shoe, in accordance with implementations of the present disclosure;

The drawings described herein are for illustrative purposes only of select embodiments and not all possible implementations. The drawing figures are not necessarily drawn to scale, but instead are drawn to provide a better understanding of the components thereof, and are not intended to be limiting in scope, but rather to provide exemplary illustrations. According to the present disclosure, the figures illustrate exemplary embodiments of a joint mobilization appliance and the components thereof, and in no way limit the structures or configurations employed by other orthopedic devices and orthoses, and their components thereof.

### DETAILED DESCRIPTION

Embodiments of a joint mobilization appliance are described herein and illustrated in the accompanying figures. The joint mobilization appliance can be used in environments in which it is desirable to diagnose, prevent, monitor, treat, alleviate or compensate for an injury; however, the illustrative examples provided are not intended to preclude embodiments of the joint mobilization appliance that may or may not yet be cleared for public use and commercial distribution. The joint mobilization appliance can include components which may be removable and replaceable, as well as washable and reusable.

Embodiments of a joint mobilization appliance are provided for use in stabilizing and supporting the lower leg, ankle, and foot. In each of the embodiments, features that are provided for one side of the device can be provided on the other side of the device. In this manner, it is intended that any of the embodiments of the joint mobilization appliance described herein may be used on either the right or left lower leg, ankle, and foot, with any appropriate reconfiguration of components that is deemed necessary for proper fit, form, and function of the appliance in support and stabilization of either the left or right distal lower extremity. Although the illustrated embodiments show the cable pulley system disposed on the medial side of the joint mobilization appliance when used on the right ankle, the appliance can instead be configured with the cable pulley system on the lateral side when used on the right ankle and similarly reconfigurable from side to side with regard to the left ankle.

Additionally, embodiments of a joint mobilization appliance are provided for use to stabilize an ankle joint that has been weakened by injury or other infirmities. The appliance is configured to be properly tightened by all users, including the elderly or infirm.

In accordance with the present disclosure, embodiments of the joint mobilization appliance are particularly adapted for a human ankle joint and human talus bone, and can be dimensioned to accommodate different types, shapes, and sizes of human ankle joints and limbs.

In accordance with the present disclosure, each joint mobilization appliance embodiment or component thereof described herein may be divided into sections which are denoted by general anatomical terms for the human body. Such anatomical terms are provided to distinguish various elements of the device embodiments from one another, but which are not to be considered to limit the scope of the disclosure.

The embodiments of the joint mobilization appliance can be considered to fall within anterior and posterior sections by an anterior-posterior plane. The anterior-posterior plane generally corresponds to the coronal or frontal plane of a human leg. A posteriorside or element is therefore located behind this anterior-posterior plane, whereas an anterior side or element is located in front of the anterior-posterior plane. Also, with regard to embodiments of the joint mobilization appliance, an aspect of body part mobilization, i.e., pushing a body part from the anterior side to the posterior side, occurs in the sagittal plane, crossing the frontal plane.

The terms medial and lateral are relative terms that are generally understood as indicating location with respect to the longitudinal or sagittal plane of the body. Therefore, elements that are located near the body midline are referred to as medial and those elements that are further from the midline are considered to be lateral.

The terms inward or inner commonly used herein to distinguish the side or a face of the appliance that may be directed to the medial or lateral side of the appliance and specifically adjacent to the leg of the human subject using the device. Contrariwise, the terms outward or outer can be used to denote the side of the device that is opposite to the inward side.

The terms rigid, semi-rigid, and flexible may be used herein to distinguish characteristics of portions of the frame and foot orthotic, in accordance with embodiments of the joint mobilization appliance. The term rigid is intended to denote that the frame is generally devoid of flexibility. Within the context of frame members that are rigid, it is intended to indicate that they may break if bent with sufficient force. On the other hand, the term flexible is intended to denote that features are capable of repeated bending. The term semi-rigid can denote the element is capable of supporting a weight bearing article with some deformity to the element but may be used to qualify such flexible properties as generally returning to the initially molded shape without permanent deformation.

The embodiments of the joint mobilization appliance can also be considered in terms of the intensity of the mobilization. The intensity variable is categorized in a grading system, e.g., the translatory glide mobilization grading has five grades (Grades I-V) ranging from small amplitude movement at the beginning of the available range of motion of the joint, or Grade I, to a high velocity thrust of small amplitude at the end of the available range and within its anatomical range (manipulation), or Grade V.

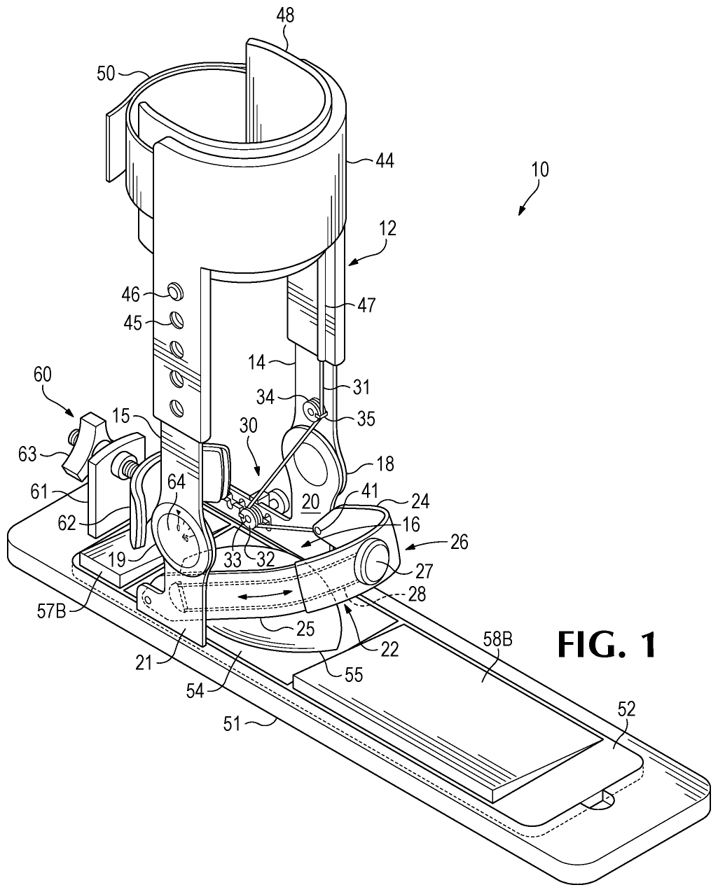

Now, referring to the figures wherein like reference numerals denote like structure throughout the specification, with reference primarily to FIG. 1, joint mobilization appliance 10 includes frame 12 and spaced apart dual struts 14, 15. First strut 14 and second strut 15 of the frame 12 define an anterior opening 16 therebetween. First strut 14 and second strut 15 are coupled to first hinge 18 and second hinge 19. Hinges 18, 19 are coupled to first brace 20 and second brace 21. The braces 20, 21 are coupled to baseplate 51. The illustrative examples of the frame 12 and struts 14, 15, hinges 18, 19 and braces 20, 21 are not intended to preclude embodiments which incorporate similar or equivalent single or multiple support members and structures used for load bearing and weight bearing orthopedic devices and orthoses, currently or prospectively available.

In a non-limiting embodiment of the frame 12 of the joint mobilization appliance 10 and according to the principles of the present disclosure, the frame 12 and the components of the frame 12, including the baseplate 51 can, but not necessarily, be formed or constructed or manufactured from a metal material, such as but not limited to steel, aluminum, or titanium-based material, or plastic or other rigid polymer material, carbon fiber or other carbon-based material.

In another non-limiting embodiment, the frame 12, including the baseplate 51 can, but not necessarily, be formed or constructed or manufactured from a semi-rigid elastomeric material using additive manufacturing. Suitable elastomeric materials can include, but are not limited to, thermoplastic elastomers, acrylonitrile butadiene styrene, poly(styrene-butadiene-styrene), polybutadiene, polyamides, epoxy resins, silicones, olefinic materials, and other thermoplastics infused with antibacterial metals.

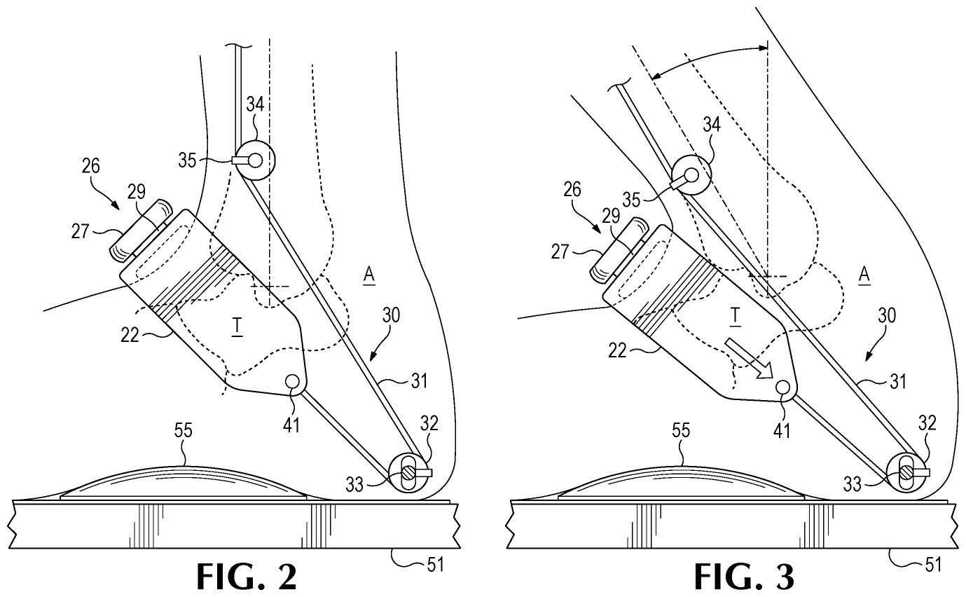

With continuing reference to FIG. 1, talar strap 22 of the joint mobilization appliance 10 can include a hollow first portion 24 and a second portion 25, such that the second portion 25 of the talar strap 22 is coupled at a second end of the second portion 25 to the second brace 21. Talar strap 22 can extend across the medial-lateral plane between the first strut 14 and second strut 15 of the frame 12. A buckle having a guide or similar suitable element can, but not necessarily, be used to tighten the talar strap 22 about the talus hone T (see FIGS. 2-3). The example of the buckle as conventionally used with a strap is not intended to preclude embodiments which incorporate similar or equivalent tightening elements or mechanisms, such as clips, belts, clamps, and rings, currently or prospectively available.

Still, with continuing reference to FIG. 1, the joint mobilization appliance 10 can also include a tensioner 26 as a rotary tension mechanism coupled to the talar strap 22. The tensioner 26 can, but not necessarily, include a dial 27, a push-release 29 (see FIG. 2) to deactivate the tensioner 26, and a reel assembly 28, which can, but not necessarily, be made of laces, cords, strings, wires, or cables, and a system of guides. When the dial tensioner 26 is rotated in a first direction the hollow first portion 24 of the talar strap 22 incrementally envelops the second portion 25 of the talar strap 22 resulting in a stabilization of the talus bone T (see FIGS. 2-3). A commercially available example of a rotary tension mechanism is the BOA® Fit System by BOA Technology. The illustrative example of the tensioner 26 is not intended to preclude embodiments which incorporate similar or equivalent rotary tension mechanisms or rotary ratchets, currently or prospectively available.

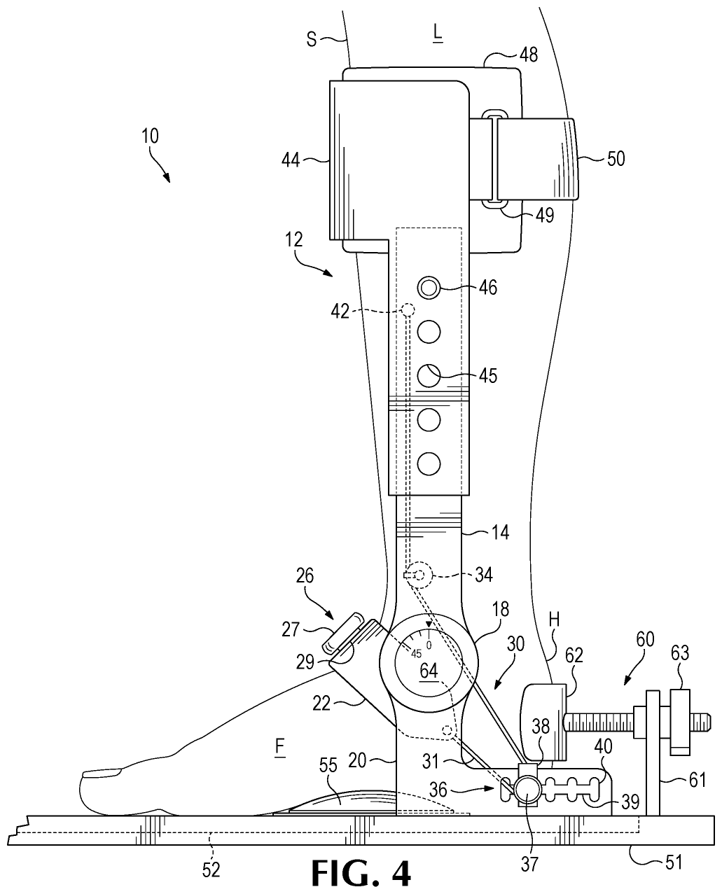

Referring now to FIGS. 2-4 and with continuing reference to FIG. 1, in operation of the dial tensioner 26, the talar strap 22 is forcibly pulled against the talus bone T of the human subject S. The resultant force is a stabilizing force which mimics the force applied by a physical therapist when performing a joint mobilization of the ankle. The talar strap 22 can be made from materials suitable for positioning, securement, and stabilization of human bone, including hook and loop, latex-free, nylon, nylon/foam, poly/nylon, soft foam and soft/strong non-woven or woven covered in a softer material, such as foam, so that the strap material does not dig into the soft tissue.

Use of the talar strap 22 and tensioner 26 as incorporated into an embodiment of the joint mobilization appliance 10 can help to avoid the lack of reproducibility from one physical therapy practitioner to the next. Although the physical therapy practitioner's joint mobilization technique is not necessary when using the joint mobilization appliance 10, the physical therapy practitioner or practitioners can instead devise treatment regimens for the subject's S use of the joint mobilization appliance 10. In addition, regimens can be developed to orient principal forces exerted by the talar strap 22 at any desirable location to treat other ankle A and foot F infirmities.

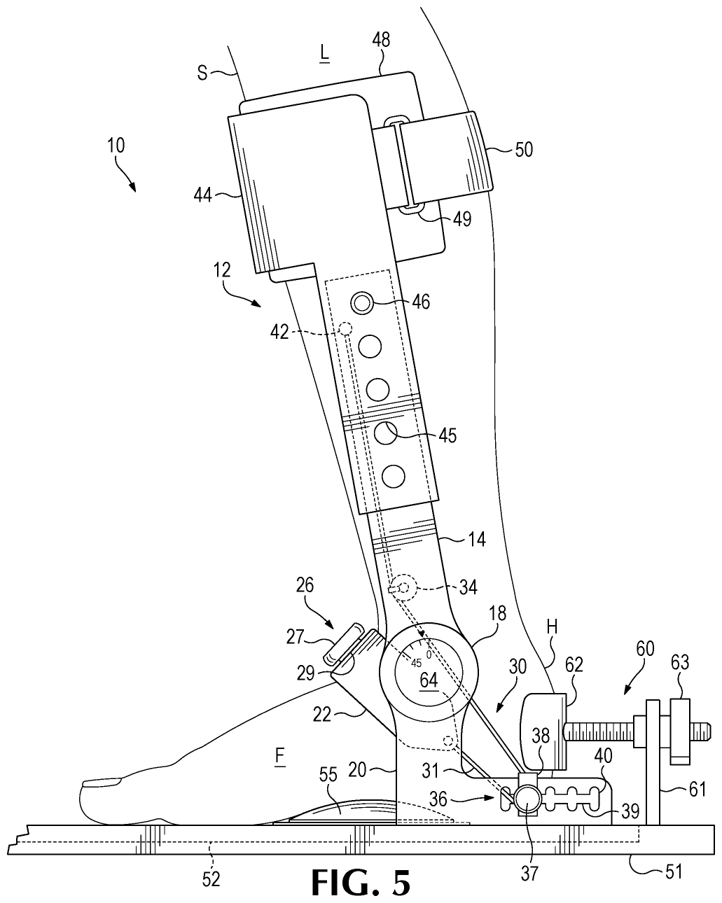

With continuing reference to FIGS. 1-4 and now referring to FIG. 5, the dual struts 14, 15 of the frame 12 define an anterior opening 16 between the struts 14, 15 to substantially receive at least one of a lower leg L, ankle A, and foot F of the human subject S. The dual struts 14, 15 oppositely disposed in parallel to one another with the first strut 14 and the second strut 15 each pivotally hinged to the first brace 20 and the second brace 21. Cable pulley system 30 including a cable 31 and at least one pulley wheel 32 with an axle 33 is fixed to the frame 12 and the talar strap 22. The cable 31 includes a first end coupled to the first end of the talar strap 22 and a second end of the cable 31 is coupled to the first strut 14 of the frame 12 along the longitudinal length of the first strut 14. Pulley wheel 32 is mounted along the horizontal length of the first brace 20 extending posteriorly and adjustably selectable along the horizontal length of the first brace 20 by way of the pulley wheel adjuster 36. Guide 34 can, but not necessarily, be mounted to the first strut 14 along the longitudinal length of the first strut 14 to accommodate for the tension created by adjusting the pulley wheel 32 anteriorly along the pulley wheel adjuster 36. The illustrative examples of the cable pulley system 30 and cable 31 are not intended to preclude embodiments which incorporate similar or equivalent straps, brackets, hook and loop fastener systems, or ratcheting means, such as a linear, ladder or buckle ratchet, or a combination thereof, that permit adjusting tension against the distal lower extremity of the subject S, currently or prospectively available.

Still, with continuing reference to FIGS. 1-5, cable 31 is routed from a first end 41 coupled to the talar strap 22 to a second end 42 coupled to the first strut 14 under low friction via pulley wheel 32, guide 34, and cable sleeve 47. Cable managers 35 can, but not necessarily, be included as attached to the pulley wheel 32 and guide 34. The pulley wheel adjuster 34 includes pull knob 37 and mount 38 with a linear extension 39 and lock 40. The frame 12 is adjustable longitudinally with push button slots 45 disposed within the cuff 44 and a push button 46. The frame 12 is also adjustable around the lower leg L with contour wrap 48, clasp 49, strap 50 which can, but not necessarily, be a hook and loop fastener. The frame 12 can, but not necessarily, be repositionable and biased back to a resting position or position of reset by way of a spring-loaded return attached to contradict the articulation of the hinges 18, 19.

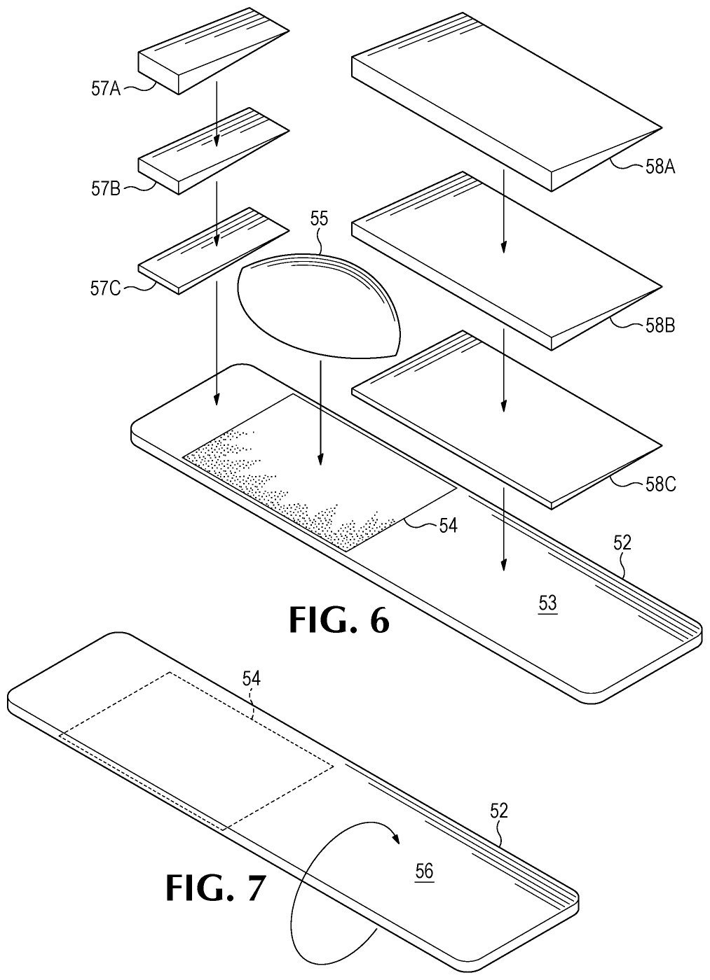

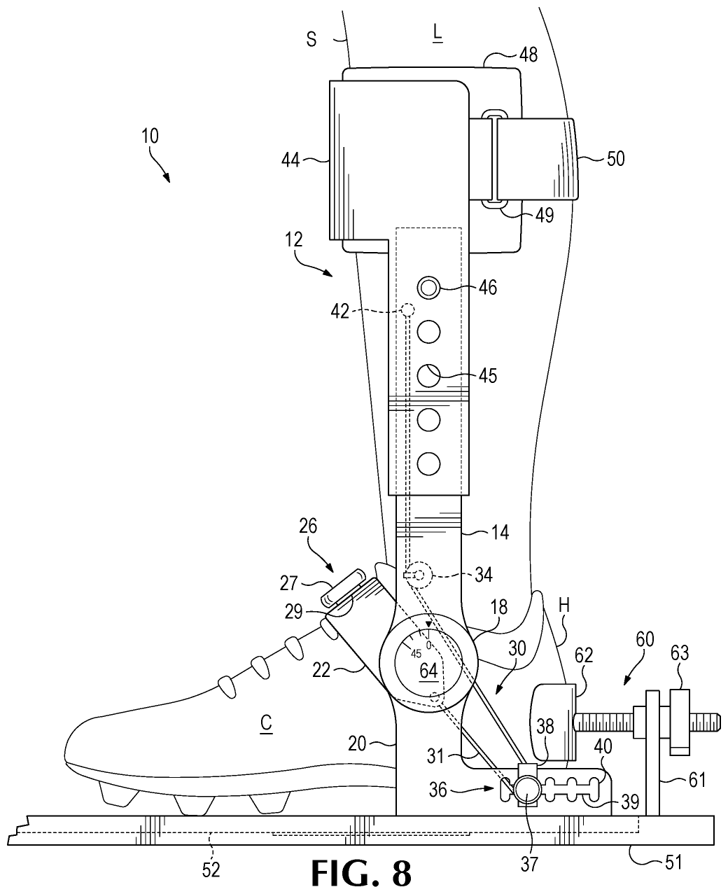

Referring to FIGS. 6-7, foot orthotic 52 can be detachably coupled to the baseplate 51. The baseplate is coupled to the first brace 20 and second brace 21 of the frame 12. Foot orthotic 52 includes a first side 53 with a hook and loop fastener 54 for easy positioning and repositioning of arch support 55. Wedges 57A, 57B, 57C and 58A, 58B, 58C of varying degrees of incline can be positioned and repositioned atop of or anteriorly-posteriorly/medially-laterally adjacent to the foot orthotic 52 to modify positioning of the ankle. A second side 56 of the foot orthotic 52 can be used alternatively, for example, when the Subject S is donning a shoe C (see FIG. 8 illustrating a cleated shoe).

In a non-limiting embodiment, the foot orthotic 52 and wedges 57A, 57B, 57C and 58A, 58B, 58C can, but not necessarily, be formed or constructed or manufactured from semi-rigid materials, such as foams, silicones, and thermoplastics and can be infused with antibacterial materials.

With reference to FIGS. 1-5 and FIG. 8, heel support 60 includes bracket 61 and backstay 62 for securely positing and supporting the heel H of the subject S. The backstay 62 is adjustable by way of the wing drive 63.

With reference to FIGS. 2-4, in use and operation, the subject S begins by slowing driving the subject's S knee anteriorly towards a distal end of the foot F, resulting in a pivot actuation of the dual struts 14, 15 which, in turn, tensions the cable pulley system 30. The foot F, including the talus bone remain stationary while the tibia and fibula glide anteriorly. The movement by the Subject S to drive the knee anteriorly toward the distal end of the foot F can, but not necessarily, occur in more than the sagittal plane, i.e., the movement can occur in the transverse and frontal planes, as well. Goniometer 64 can be used to estimate the degree of ankle dorsiflexion. The physical therapist can model the joint mobilization appliance 10 and its settings, features, and use for the next session to enable the subject S to perform the ankle dorsiflexion unassisted. In addition to assisted use under the treatment of a physical therapist, the joint mobilization appliance 10 can be used unassisted at home, or in the gym and on the field prior to and during a competition.

The description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used is for the purpose of describing particular example embodiments only and is not intended to be limiting. The singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section could be termed a second element, component, region, layer or section without departing from the teachings of the example embodiments.

Spatially relative terms, such as “inner,” “outer,” “beneath,” “below,” “lower,” “above,” “upper,” and the like, may be used for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It is understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, quadrants, thirds, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims. All references recited herein are incorporated herein by specific reference in their entirety.

What is claimed is:

1. A joint mobilization appliance, comprising:
a frame comprising spaced-apart dual struts defining an anterior opening between the struts to substantially receive a lower leg, ankle, and foot of a human subject, the dual struts oppositely disposed in parallel to one another and each having an inward facing side, a first strut and a second strut of the dual struts each pivotally hinged to a first brace and a second brace;
a talar strap comprising a tensioner to stabilize a talus bone of the human subject;
a cable pulley system comprising a cable and at least one pulley wheel with an axle, the at least one pulley wheel mounted on the frame, the cable having a first end and a second end, the first end of the cable coupled to a first end of the talar strap, the cable strung in a posterior direction from the first end of talar strap to engage at least a portion of the at least one pulley wheel, the cable strung in a proximal direction from the at least one pulley wheel along the inward facing side of the first strut, the second end of the cable coupled to the first strut toward a proximal end of the first strut;
a foot orthotic constructed to at least partially receive the foot of the human subject, the foot orthotic detachably coupled to a baseplate, the baseplate coupled to the first brace and second brace of the frame with the dual struts substantially perpendicular to the frame; and
a heel bracket mounted to the baseplate, the heel bracket comprising an adjustably repositionable backstay to substantially receive at least a heel of the human subject,
wherein the human subject drives at least a portion of a knee of the human subject anteriorly towards a distal end of the foot of the human subject resulting in a pivot actuation of the dual struts to tension the cable pulley system.

2. The joint mobilization appliance of claim 1, wherein the first strut comprises an extension of the first brace in a posterior direction, the at least one pulley wheel adjustably repositionable along a length of the extension to tension the cable pulley system.

3. The joint mobilization appliance of claim 1, wherein the tensioner comprises a dial and reel assembly in which rotation of the dial in a first direction urges a hollow first portion of the talar strap to envelop a second portion of the talar strap and forcibly pull the talar strap substantially against a talus bone of the human subject, a second end of the second portion of the talar strap coupled to the second brace.

4. The joint mobilization appliance of claim 1, wherein the frame further comprises a cuff, the cuff having a hook and loop fastener approximately contoured to correspond to at least a portion of the lower leg of the human subject, the cuff adjustably repositionable along a longitudinal length of the dual struts to adjust a height of the cuff.

5. The joint mobilization appliance of claim 1, wherein the foot orthotic comprises a detachably securable semi-rigid insert approximately shaped to support at least a portion of an arch of the foot of the human subject and a set of detachably securable and repositionable semi-rigid wedges having varying degrees of incline.

6. The joint mobilization appliance of claim 1, wherein the frame comprises a goniometer.

7. A joint mobilization appliance, comprising:
a frame comprising spaced-apart dual struts defining an anterior opening between the struts to substantially receive a lower leg, ankle, and foot of a human subject, the dual struts oppositely disposed in parallel to one another and each having an inward facing side, a first strut and a second strut of the dual struts each pivotally hinged to a first brace and a second brace;
a talar strap comprising a tensioner to stabilize a talus bone of the human subject;
a cable pulley system comprising a cable and at least one pulley wheel with an axle, the at least one pulley wheel mounted on the frame, the cable having a first end and a second end, the first end of the cable coupled to a first end of the talar strap, the cable strung in a posterior direction from the first end of talar strap to engage at least a portion of the at least one pulley wheel, the cable strung in a proximal direction from the at least one pulley wheel along the inward facing side of the first strut, the second end of the cable coupled to the first strut toward a proximal end of the first strut; and
a heel bracket mounted to a baseplate, the heel bracket comprising an adjustably repositionable backstay to substantially receive at least a heel of the human subject, the baseplate coupled to the first brace and second brace of the frame with the dual struts substantially perpendicular to the frame,
wherein the human subject drives at least a portion of a knee of the human subject anteriorly towards a distal end of the foot of the human subject resulting in a pivot actuation of the dual struts to tension the cable pulley system.

8. The joint mobilization appliance of claim 7, wherein the first strut comprises an extension of the first brace in a posterior direction, the at least one pulley wheel adjustably repositionable along a length of the extension to tension the cable pulley system.

9. The device of claim 7, wherein the tensioner comprises a dial and reel assembly in which rotation of the dial in a first direction urges a hollow first portion of the talar strap to envelop a second portion of the talar strap and forcibly pull the talar strap substantially against a talus bone of the human subject, a second end of the second portion of the talar strap coupled to the second brace.

10. The device of claim 7, wherein the frame further comprises a cuff, the cuff having a hook and loop fastener approximately contoured to correspond to at least a portion of the lower leg of the human subject, the cuff adjustably repositionable along a longitudinal length of the dual struts to adjust a height of the cuff.

11. The device of claim 7, further comprising:
a foot orthotic constructed to at least partially receive the foot of the human subject, the foot orthotic detachably coupled to the baseplate.

12. The device of claim 11, wherein the foot orthotic comprises a detachably securable semi-rigid insert approximately shaped to support at least a portion of an arch of the foot of the human subject and a set of detachably securable and repositionable semi-rigid wedges having varying degrees of incline.

13. The device of claim 7. wherein the frame comprises a goniometer.

14. A device arranged for dynamically treating a lower distal extremity, the device having a frontal plane dividing the device along anterior and posterior sides, the device having a medial-lateral plane dividing the device into medial and lateral sides and generally oriented perpendicular to the frontal plane, the device comprising:
a first hinge and a second hinge;
a frame having first and second struts spaced apart from one another as longitudinal extensions from the first hinge and the second hinge, the first and second struts connected to one another by a cuff;
a strap extending between medial and lateral sides of the frame;
a strap tensioner coupled to the strap, wherein tension about the strap by the strap tensioner pulls the strap against a talus bone of the lower distal extremity;
a cable system engaged to at least one pulley with a first end of a cable coupled to the strap and a second end of the cable coupled to the first strut, wherein articulation of the first hinge and the second hinge towards the frontal plane pulls the cuff away from the frontal plane by activation of the at least one pulley;
wherein at least one goniometer is arranged to align with an outward face of at least one of the first and second hinge.
